(19) United States
(12) Patent Application Publication
(10) Pub. No.: US 2019/0136886 A1
(43) Pub. Date: May 9, 2019

(54) WELDING METHOD AND CORNER JOINT COMPONENT

(71) Applicant: TOYOTA JIDOSHA KABUSHIKI KAISHA, Toyota-shi (JP)

(72) Inventor: Yuki KAWASHITA, Anjo-shi (JP)

(73) Assignee: TOYOTA JIDOSHA KABUSHIKI KAISHA, Toyota-shi (JP)

(21) Appl. No.: 16/149,247

(22) Filed: Oct. 2, 2018

(30) Foreign Application Priority Data
Nov. 7, 2017 (JP) 2017-214352

(51) Int. Cl. F16B 5/08

(52) U.S. Cl. CPC F16B 5/08

(57) ABSTRACT

The present disclosure provides a welding method capable of welding together plates while effectively preventing misalignment of the plates. In the welding method, first and second plate-like members, which are butted against each other in an L shape, are welded to form a corner joint part. The welding method includes plate processing steps and welding steps. In the plate processing steps, a plate-like material is processed to form the first and second plate-like members. In the welding steps, the first and second plate-like members are butted against each other in an L shape, and then welded together while first and second flat parts and first and second projecting parts are meshed with one another.

### CROSS REFERENCE TO RELATED APPLICATIONS

This application is based upon and claims the benefit of priority from Japanese patent application No. 2017-214352, filed on Nov. 7, 2017, the disclosure of which is incorporated herein in its entirety by reference.

### BACKGROUND

The present disclosure relates to a welding method. In particular, the present disclosure relates to a method for welding a corner joint part.

A welding method disclosed in Japanese Unexamined Patent Application Publication No. 2017-148858 includes butting two plates against each other in an L shape, and welding a butted part to form a corner joint part.

### SUMMARY

The present inventors have found the following problem. The plates of a welded product welded by such a welding method have been sometimes misaligned. One of the possible causes of such misalignment may lie in direct butting between an end surface of one plate and a main front surface of an end of the other plate.

The present disclosure is to enable plates to be welded together while effectively preventing the misalignment of the plates.

A method according to the present disclosure for welding together a first plate-like member and a second plate-like member that are butted against each other in an L-shape to form a corner joint part,

the first plate-like member including a first butted part butted against the second plate-like member,

the first butted part including a first flat part and a first projecting part that projects from the first flat part in a direction in which the first plate-like member is butted against the second plate-like member,

the second plate-like member including a second butted part butted against the first plate-like member, and

the second butted part including a second flat part and a second projecting part that projects from the second flat part in a direction in which the second plate-like member is butted against the first plate-like member. The method includes:

a plate processing step of processing a plate-like material to form the first plate-like member and the second plate-like member in such a way that when the first and second butted parts are butted against each other, the first and second flat parts and the first and second projecting parts are meshed with one another; and

a welding step of butting the first and second plate-like members against each other in an L shape and welding together the first and second plate-like members while the first and second flat parts and the first and the second projecting parts are meshed with one another.

With such a configuration, the first and second plate-like members are welded together while the first and second flat parts and the first and second projecting parts are meshed with one another. Thus, movements of the first and second plate-like members relative to each other are effectively prevented. That is, the first and second plate-like members are welded together with reduced misalignment between them.

In the welding method according to the present disclosure, in the plate processing step, the plate-like material is processed in such a way that a projecting length of the first projecting part projecting from the first flat part becomes greater than a thickness of the second plate-like member or that a projecting length of the second projecting part projecting from the second flat part becomes greater than a thickness of the first plate-like member.

With such a configuration, the projecting length of the projecting part of the butted part of one plate member is greater than the thickness of the other plate-like member. Thus, the amount of melting is abundant in the welding step. Therefore, welding accuracy can be improved with reduced misalignment between the plates.

A corner joint component according to the present disclosure includes a corner joint part.

The corner joint part includes a first plate-like member and a second plate-like member,

the first and second plate-like members are butted against each other in an L-shape,

a part where the first and second plate-like members are butted against each other includes a plurality of welded parts and depressed parts, and

the depressed part is disposed between the plurality of welded parts.

With such a configuration, before the corner joint part is formed, the first and second plate-like members are butted against each other in an L shape and then welded together while the first and second flat parts and the first and second projecting parts are meshed with one another. The first and second plate-like members are welded together while the first and second flat parts and the first and second projecting parts are meshed with one another. Thus, the first and second plate-like members can be welded together with reduced misalignment between them. The meshed adjacent projecting parts of the first and second plate-like members are not practically brought into close contact with one another with predetermined spaces therebetween. When the meshed first and second plate-like members are welded together, the corner joint part can be formed while absorbing thermal strain by these spaces. Some of these spaces remain after the welding to form the depressed parts. That is, it is possible to perform the welding while effectively reducing the influence of the thermal strain.

Further, a sum of welded lengths of the plurality of welded parts may exceed 50% of a length of the part where the first and second plate-like members are butted against each other.

With such a configuration, the sum of the welded lengths of the plurality of welded parts exceeds the sum of lengths of unwelded parts, i.e., the sum of non-welded lengths, at the part where the first and second plate-like members are butted against each other. Therefore, it is possible to perform the welding while achieving favorable mechanical strength and effectively reducing the influence of the thermal strain.

The present disclosure enables plates to be welded together while effectively preventing misalignment of the plates.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing one step of a welding method according to a first embodiment;

FIG. 2 is an enlarged perspective view showing one step of the welding method according to the first embodiment;

FIG. 3 is an enlarged front view showing one step of the welding method according to the first embodiment;

FIG. 4 is a perspective view showing one step of the welding method according to the first embodiment;

FIG. 5 is a perspective view showing one step of the welding method according to the first embodiment;

FIG. 6 is an enlarged perspective view showing one step of the welding method according to the first embodiment;

FIG. 7 is a perspective view showing one step of the welding method according to the first embodiment;

FIG. 8 is an enlarged perspective view showing one step of the welding method according to the first embodiment;

FIG. 9 is a cross-sectional view of a main part of a corner joint component;

FIG. 10 is a cross-sectional view of the main part of the corner joint component; and

FIG. 11 is a perspective view showing one step of a modified example of the welding method according to the first embodiment.

### DESCRIPTION OF EMBODIMENTS

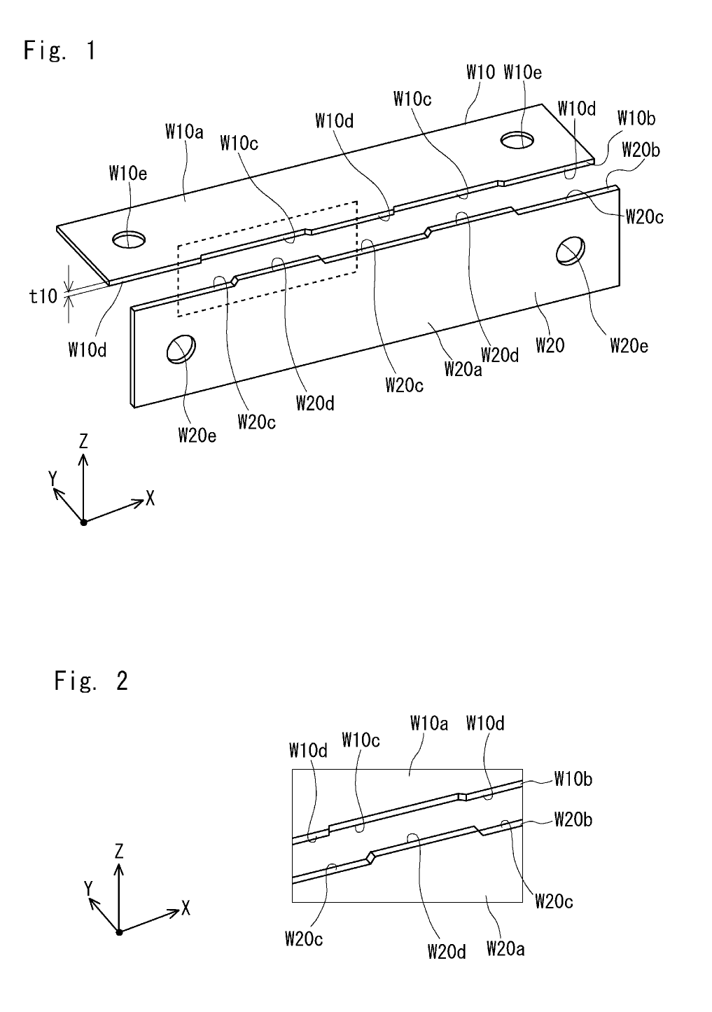

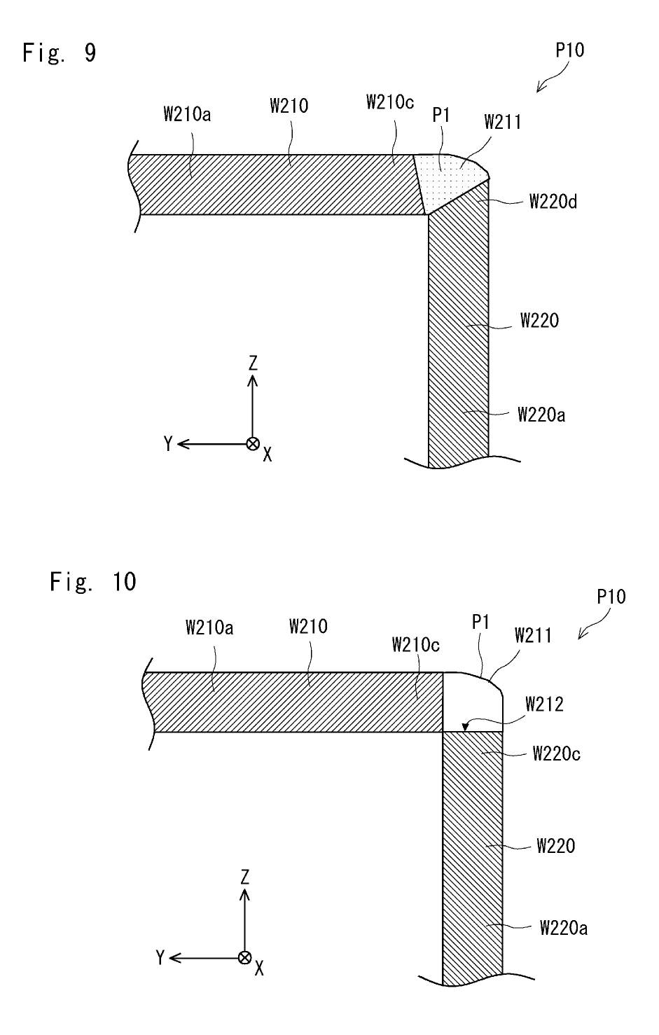

Hereinafter, a specific embodiment to which the present disclosure is applied will be described in detail with reference to the drawings. However, the present disclosure is not limited to the following embodiment. The following descriptions and drawings are simplified as appropriate in order to clarify the descriptions. In FIGS. 1 to 11, right-handed xyz three-dimensional coordinates are defined.

### First Embodiment

A welding method according to a first embodiment will be described with reference to FIGS. 1 to 3.

As shown in FIGS. 1 and 2, one or two plate-like materials (not shown) are processed to form a plate-like member W10 (also referred to as a first plate-like member) and a plate-like member W20 (also referred to as a second plate-like member) (plate processing step ST1). Various kinds of processing methods can be used as the processing method. For example, a processing method using a laser or an industrial blade can be used. A surface processing method may be used as appropriate. The plate-like member W10 and the plate-like member W20 are made of a material that can be welded or joined. Examples of such materials include Fe, Al, Mg, and an alloy thereof. Specifically, a hot steel plate or a cold steel plate can be used as the plate-like members W10 and W20.

To be more specific, in a welding step ST2, which will be described later, a plate-like material (not shown) is processed in such a way that, when a butted part W10b and a butted part W20b are butted against each other, flat parts W10c, flat parts W20c, projecting parts W10d, and projecting parts W20d are meshed with one another.

The plate-like member W10 includes a plate-like main body W10a and a butted part W10b connected to the main body W10a. The butted part W10b includes the flat parts W10c and the projecting parts W10d projecting from the flat parts W10c. Note that the flat part W10c sandwiched between the two projecting parts W10d functions as a depressed part depressed from the projecting parts W10d. The main body W10a includes reference holes W10e, which serve as references of positions as necessary in this step and before and after this step.

The plate-like member W20 includes a plate-like main body W20a and the butted part W20b connected to the main body W20a. The butted part W20b includes the flat parts W20c and the projecting parts W20d projecting from the flat parts W20c. Note that the flat part W20c sandwiched between the two projecting parts W20d functions as a depressed part depressed from the projecting part W20d. The main body W20a includes reference holes W20e, which serve as references of the positions as necessary in this step and before and after this step.

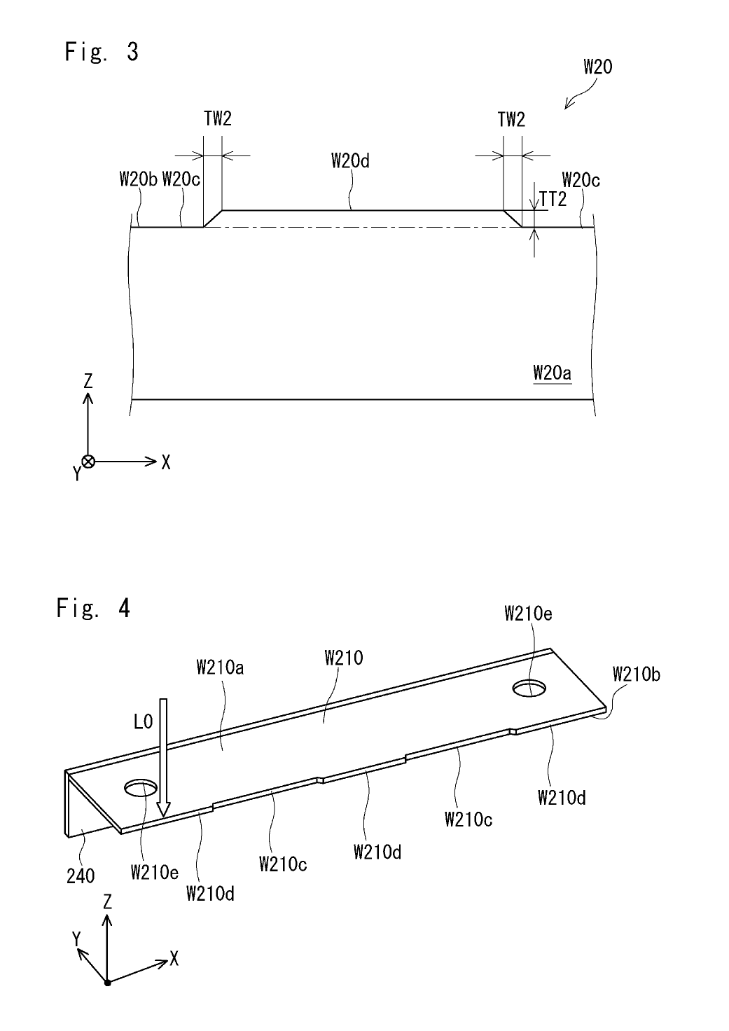

As shown in FIG. 3, a projecting length TT2 of the projecting part W20d of the plate-like member W20 projecting from the flat part W20c is preferably greater than a thickness t10 (see FIG. 1) of the plate-like member W10. The projecting length TT2 is preferably limited to a predetermined length so that weldability required in the welding step ST2, which will be described later, can be achieved. The projecting part W20d preferably projects obliquely from the flat part W20c. A tapered length TW2 from a boundary between the flat part W20c and the projecting part W20d in a longitudinal direction of the plate-like member W20 to a leading end of the projecting part W20d is predetermined. Thus, in the welding step ST2, which will be described later, when the butted part W10b and the butted part W20b are butted against each other, the projecting parts W20d and the projecting parts W10d are not practically brought into close contact with one another with predetermined spaces therebetween. The stress concentration is low when the projecting parts W20d project obliquely from the flat parts W20c, as compared with the case where the projecting parts W20d project almost vertically from the flat parts W20c.

Like the projecting part W20d, a projecting length of the projecting part W10d projecting from the flat part W10c is preferably greater than the thickness of the plate-like member W20. Like the projecting part W20d, the projecting part W10d preferably projects obliquely from the flat part W10c. Further, like the projecting part W20d, the projecting length of the projecting part W10d projecting from the flat part W10c is preferably limited to a predetermined length so that weldability required in the welding step ST2, which will be described later, can be achieved.

Next, the plate-like member W10 and the plate-like member W20 are butted against each other in an L shape. Then, the plate-like member W10 and the plate-like member W20 are welded together while the flat parts W10c, the flat parts W20c, the projecting parts W10d, and the projecting parts W20d are meshed with one another (the welding step ST2).

To be more specific, firstly, the plate-like member W10 and the plate-like member W20 are butted against each other in an L shape to let the flat parts W10c, the flat parts W20c, the projecting parts W10d, and the projecting parts W20d be meshed with one another. Thus, the butted part W10b is butted against the plate-like member W20. The projecting parts W10d project from the flat parts W10c in a direction in which the plate-like member W10 is butted against the plate-like member W20 (e.g., a Y-axis negative direction). The butted part W20b is butted against the plate-like member W10. The projecting parts W20d project from the flat parts W20c in a direction in which the plate-like member W20 is butted against the plate-like member W10 (e.g., a Z-axis positive direction).

Next, the butted part W10b and the butted part W20b, which have been butted against each other, are welded together. Various kinds of welding methods can be used as the welding method. For example, a laser welding method can be used. When the laser welding method is used, at the boundary between the butted part W10b and the butted part W20b, which have been butted against each other, and the vicinity of this boundary, the projecting parts W10d and W20d are irradiated with a laser to weld the butted parts W10b and W20b in such a way that a plurality of welded parts are formed. For example, the adjacent projecting parts W10d and W20d is preferably spaced apart from each other by a predetermined distance. The plurality of welded parts may be arranged, for example, like stitches.

In this manner, the butted parts W10b and W20b are welded together while the flat parts W10c and W20c and the projecting parts W10d and W20d are meshed with one another. Thus, the plate-like members W10 and W20 are welded together while they are restrained from moving in the longitudinal direction of the butted parts W10b and W20b (in this case, the X-axis direction), the direction in which the plate-like member W10 is butted against the plate-like member W20 or the opposite direction (in this case, the Y-axis direction), and the direction in which the plate-like member W20 is butted against the plate-like member W10 or the opposite direction (in this case, the Z-axis direction), respectively. That is, the plate-like members W10 and W20 are welded together while their movements relative to each other are effectively prevented. In other words, the plate-like members W10 and W20 are welded together with reduced misalignment between them.

### One Specific Example of Welding Method

Next, an example of the above-described welding method will be described with reference to FIGS. 4 to 6. One example of the above-described welding method includes welding one example of the plate-like members W10 and W20 to form a tubular body.

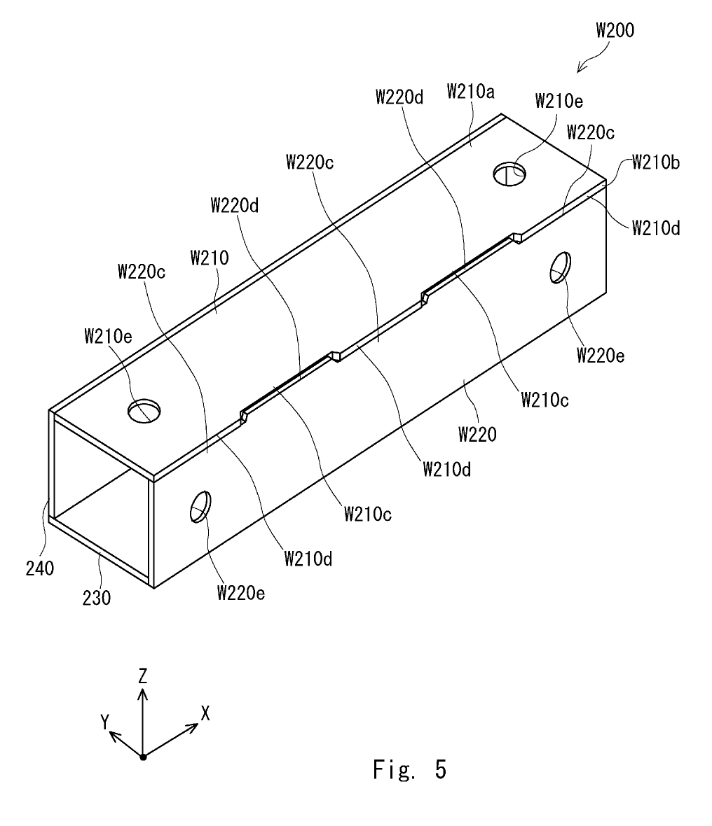

As shown in FIG. 4, a plate-like material (not shown) is irradiated with a laser beam L0 to cut the plate-like material (plate processing step ST21). Then, a plate-like member W210, which is an example of the plate-like member W10 (see FIG. 1), and a plate-like member W220 (see FIG. 5), which is an example of the plate-like member W20 (see FIG. 1), are formed. The plate-like member W210 is butted against a plate-like member W240 in an L shape and connected thereto. Further, the plate-like member W220 is butted against a plate-like member W230 in an L shape and connected thereto.

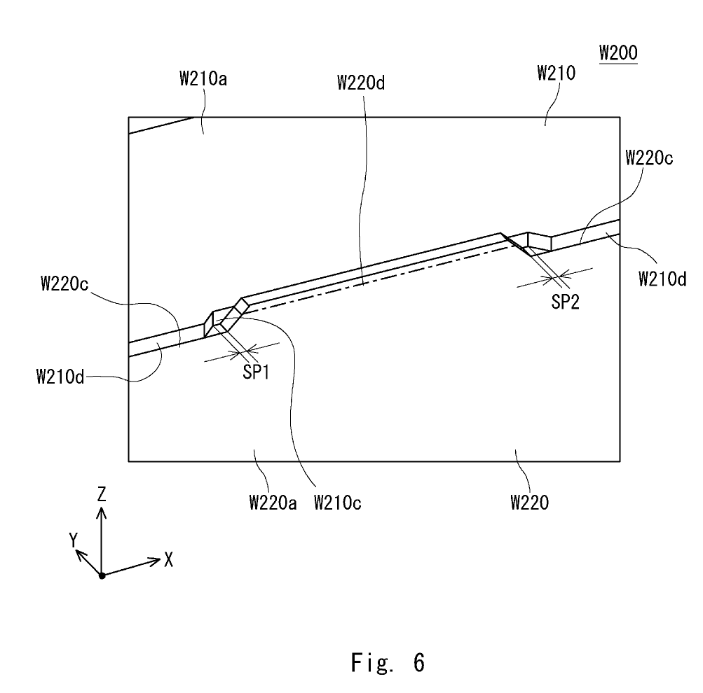

Next, as shown in FIGS. 5 and 6, the plate-like member W210 and the plate-like member W220 are butted against each other in an L shape. Then, the plate-like member W230 and the plate-like member W240 are butted against each other in an L shape, so that the plate-like members W210, W220, W230, and W240 are disposed so as to form a tubular body having a square cross section. Flat parts W210c and projecting parts W210d of the plate-like member W210 and flat parts W220c and projecting parts W220d of the plate-like member W220 are meshed with one another. There is a predetermined space between the adjacent projecting part W210d and the projecting part W220d. Each of widths SP1 and SP2 of this space is predetermined.

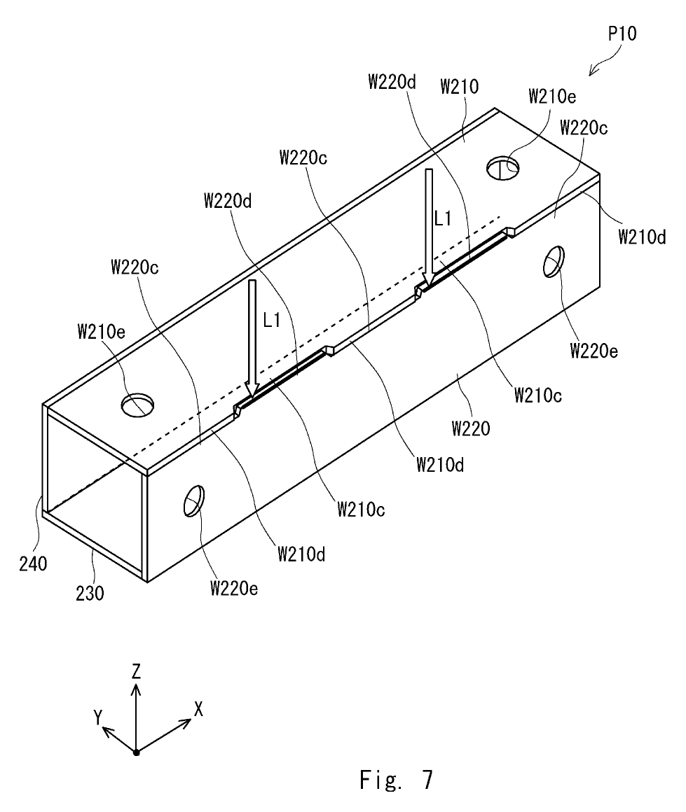

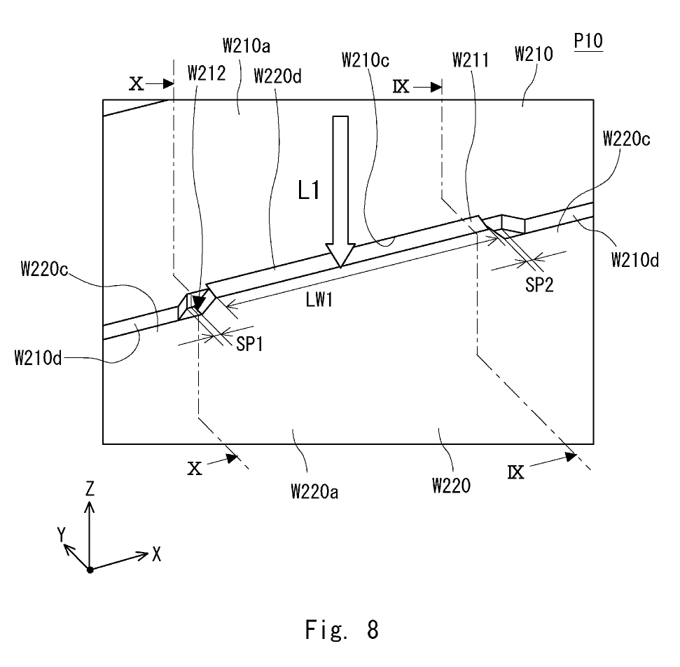

As shown in FIGS. 7 and 8, a boundary between a butted part W210b and a butted part W220b or the vicinity of the boundary is irradiated with a laser beam L1 to weld together the butted parts W210b and W220b while the flat parts W210c, the flat parts W220c, the projecting parts W210d, and the projecting parts W220d are meshed with one another (welding step ST22). Specifically, the projecting parts W210d and W220d are irradiated with a laser to melt leading edges of the projecting parts W210d and the projecting parts W220d and to melt the boundary between the butted part W210b and the butted part W220b. A molten pool solidifies and welded parts are formed between the butted part W210b and the butted part W220b, so that the butted part W210b and the butted part W220b are coupled to each other. The plurality of welded parts are formed and arranged in a dotted line or like stitches at the butted part W210b and the butted part W220b.

As described above, the plate-like members W210 and W220 are welded together while the flat parts W210c and W220c and the projecting parts W210d and W220d are meshed with one another. That is, the plate-like members W210 and W220 are welded together while their movements relative to each other are effectively prevented. In other words, the plate-like members W210 and W220 are welded together with reduced misalignment between them. Further, the spaces between the adjacent projecting parts W210d and the projecting parts W220d maintain their widths SP1 and SP2. For this reason, thermal strain that could occur in the butted part W210b and the butted part W220b due to the welding is absorbed in the spaces between the adjacent projecting parts W210d and the projecting parts W220d. It is thus possible to reduce the influence of the thermal strain to effectively prevent the misalignment between the plate-like member W210 and the plate-like member W220 and weld them together. At least a part of the projecting parts W210d and W220d is welded to form a welded part W211. A remaining part of the space between the adjacent projecting part W210d and the projecting part W220d corresponds to a depressed part W212.

Further, the plate-like member W230 and the plate-like member W240 may be processed in a manner similar to that by which the plate-like members W210 and W220 are processed in the above-described plate processing step ST21, and then welded together in a manner similar to that by which the plate-like members W210 and W220 are processed in the welding step ST22. A corner joint component P10 can be formed by such welding. Likewise, a part where the plate-like member W210 is butted against the plate-like member W240 and a part where the plate-like member W220 is butted against the plate-like member W230 may be processed in a manner similar to that by which the plate-like members W210 and W220 are processed in the plate processing step ST21 and then welded together in a manner similar to that by which the plate-like members W210 and W220 are processed in the welding step ST22.

### Example of Corner Joint Component

Next, the corner joint component P10 will be described.

As shown in FIGS. 7 to 10, the corner joint component P10 includes a corner joint part P1. The corner joint part P1 is formed at a part between the plate-like member W210 and the plate-like member W220 butted against each other in an L shape. The butted parts W210b and W220b include a plurality of the welded parts W211 and depressed parts W212. The depressed part W212 is disposed between the plurality of welded parts W211. A sum of welded lengths LW1 of the plurality of welded parts W211 may exceed 50% of a total length of the butted parts W210b and W220b butted against each other.

As described above, before the corner joint part P1 is formed, the plate-like members W210 and W220 are butted against each other in an L shape and then welded together while the flat parts W210c and W220c and the projecting parts W210d and W220d are meshed with one another. Thus, the plate-like members W210 and W220 are welded together while their movements relative to each other are effectively prevented. In other words, the plate-like members W210 and W220 are welded together with reduced misalignment between them. Further, in the meshed plate-like members W210 and W220, the adjacent projecting parts W210d and W220d are not practically brought into close contact with one another with predetermined spaces therebetween. When the meshed plate-like members W210 and W220 are welded together, the corner joint parts P1 can be formed while absorbing thermal strain by these spaces. Some of these spaces remain after the welding to form the depressed parts W212. The depressed parts W212 and the welded parts W211 effectively prevent residual stress from occurring. That is, it is possible to perform the welding while effectively preventing the residual stress from occurring.

Further, the sum of the welded lengths LW1 of the plurality of welded parts W211 could exceed 50% of the total length of the parts where the plate-like members W210 and W220 are butted against each other. In such a case, the sum of the welded lengths LW1 of the plurality of welded parts W211 exceeds the sum of lengths of unwelded parts, i.e., the sum of non-welded lengths, at the part where the plate-like members W210 and W220 are butted against each other. Therefore, it is possible to perform the welding while achieving favorable mechanical strength and effectively reducing the influence of the thermal strain.

The corner joint component P10 can be used for a variety of products. The corner joint component P10 may be used for, for example, a vehicle body structure of a vehicle etc. The corner joint component P10 may be a shape other than a tubular body having a square cross section as long as it includes a corner joint part. For example, the corner joint component P10 may be a tubular body having a cross section of a triangular or polygonal shape or may be an L-shaped or U-shaped angle.

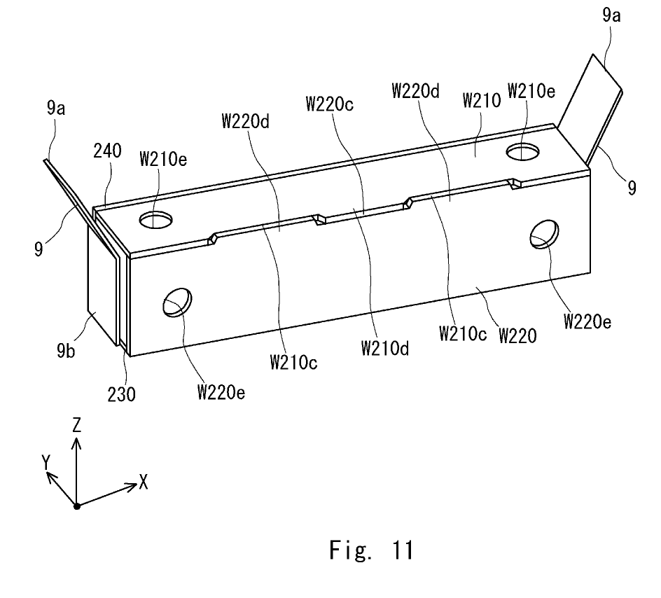

Note that the present disclosure is not limited to the above-described embodiment. Changes can be made to the present disclosure without departing from the spirit of the invention. For example, as shown in FIG. 11, in the welding step ST22 (see FIGS. 5 and 6) in one specific example of the above-described welding method according to the first embodiment, rough guides 9 may be used to butt the plate-like member W210 and the plate-like member W220 against each other in an L shape. The rough guides 9 are disposed at both ends of the plate-like member W220 in the longitudinal direction thereof. The rough guide 9 is a plate-like body extending upward from a lower end of the plate-like member W220. The rough guide 9 includes an upper part 9a extending from an upper end of the plate-like member W220 in a direction away from the plate-like member W220 in the longitudinal direction of the plate-like member W220. The plate-like member W210 falls due to its own weight along the rough guides 9, and then is butted against the plate-like member W220 in an L shape. When the plate-like member W210 is butted against the plate-like member W220, a clearance between the projecting parts W210d and the projecting parts W220d is preferably adjusted so that the flat parts W210c and W220c and the projecting parts W210d and W220d are surely meshed with one another. Such adjustment is preferable, because the flat parts W210c and W220c and the projecting parts W210d and W220d can be smoothly meshed with one another.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for welding together a first plate-like member and a second plate-like member that are butted against each other in an L-shape to form a corner joint part,
the first plate-like member comprising a first butted part butted against the second plate-like member,
the first butted part comprising a first flat part and a first projecting part that projects from the first flat part in a direction in which the first plate-like member is butted against the second plate-like member,
the second plate-like member comprising a second butted part butted against the first plate-like member, and
the second butted part comprising a second flat part and a second projecting part that projects from the second flat part in a direction in which the second plate-like member is butted against the first plate-like member, the method comprising:
a plate processing step of processing a plate-like material to form the first plate-like member and the second plate-like member in such a way that when the first and second butted parts are butted against each other, the first and second flat parts and the first and second projecting parts are meshed with one another; and
a welding step of butting the first and second plate-like members against each other in an L shape and welding together the first and second plate-like members while the first and second flat parts and the first and the second projecting parts are meshed with one another.

2. The method according to claim 1, wherein in the plate processing step, the plate-like material is processed in such a way that a projecting length of the first projecting part projecting from the first flat part becomes greater than a thickness of the second plate-like member or that a projecting length of the second projecting part projecting from the second flat part becomes greater than a thickness of the first plate-like member.

3. A corner joint component comprising a corner joint part, wherein
the corner joint part comprises a first plate-like member and a second plate-like member,
the first and second plate-like members are butted against each other in an L-shape,
a part where the first and second plate-like members are butted against each other comprises a plurality of welded parts and depressed parts, and
the depressed part is disposed between the plurality of welded parts.

4. The corner joint component according to claim 3, wherein
a sum of welded lengths of the plurality of welded parts exceeds 50% of a length of the part where the first and second plate-like members are butted against each other.
